(19) United States
(12) Patent Application Publication
(10) Pub. No.: US 2025/0061681 A1
(43) Pub. Date: Feb. 20, 2025

(54) METHODS AND SYSTEMS FOR DETERMINING IMAGE CONTROL POINT

(71) Applicant: SHANGHAI UNITED IMAGING HEALTHCARE CO., LTD., Shanghai (CN)

(72) Inventors: Liang YUE, Shanghai (CN); Yang HU, Shanghai (CN); Juan FENG, Shanghai (CN); Yan'ge MA, Shanghai (CN)

(73) Assignee: SHANGHAI UNITED IMAGING HEALTHCARE CO., LTD., Shanghai (CN)

(21) Appl. No.: 18/932,595

(22) Filed: Oct. 30, 2024

Related U.S. Application Data
(63) Continuation of application No. PCT/CN2023/102971, filed on Jun. 27, 2023.

(30) Foreign Application Priority Data
Jun. 27, 2022 (CN) 202210737490.8

(51) Int. Cl. G06V 10/25; G06T 7/13; G06T 7/136; G06T 7/33; G06V 10/26; G06V 10/28

(52) U.S. Cl. CPC G06V 10/25; G06T 7/13; G06T 7/136; G06T 7/33; G06V 10/26; G06V 10/28; G06T 2207/20021; G06T 2207/30101; G06V 2201/03

(57) ABSTRACT

Embodiments of the present disclosure provide a method and a system for determining an image control point. The method may include obtaining a first image; determining a plurality of initial control points in the first image; dividing the first image into at least two sub-regions; and determining, based on one or more features of the plurality of initial control points, one or more target control points in each of the at least two sub-regions.

### CROSS-REFERENCE TO RELATED APPLICATIONS

This application is a continuation of International Application No. PCT/CN2023/102971, filed on Jun. 27, 2023, which claims priority to Chinese Patent Application No. 202210737490.8, filed on Jun. 27, 2022, the entire contents of which are incorporated herein by reference.

### TECHNICAL FIELD

The present disclosure relates to the field of medical technique, in particular, to methods and systems for determining an image control point.

### BACKGROUND

In the current technique of medical imaging, digital subtraction angiography (DSA) has been widely used due to an ability to remove unnecessary tissue images and preserve only vascular images. Usually, an angiogram image (e.g., an image including vascular information) is subtracted from a mask image (e.g., an image without vascular information) to obtain vascular information in an image. However, due to a displacement of a patient during a period between a moment of acquisition of the mask image and a moment of acquisition of the angiogram image, the subtracted image may include motion artifacts. In order to eliminate motion artifacts, pixel displacement may be used, which means that corresponding identical points on the mask image and the angiogram image can be aligned by moving data points. However, this method usually requires selecting a control point on the image and performing a pixel transformation based on the control point. The current method for selecting the control point is a simple uniform selection or a simple gradient selection, with a single means, and the selected control point is not reasonable and have poor effectiveness. Therefore, it is desirable to provide a method and a system for determining an image control point to improve the quality of selecting the control point.

### SUMMARY

An aspect of the present disclosure provides a method implemented on at least one machine each of which has at least one processor and at least one storage device for determining an image control point. The method may include: obtaining a first image; determining a plurality of initial control points in the first image; dividing the first image into at least two sub-regions; and determining, based on one or more features of the plurality of initial control points, one or more target control points in each of the at least two sub-regions.

In some embodiments, the determining a plurality of initial control points in the first image may include extracting the plurality of initial control points in the first image using an edge detection algorithm.

In some embodiments, the determining a plurality of initial control points in the first image may include extracting feature values of a plurality of data points of the first image; selecting at least one seed point from the plurality of data points based on the feature values of the plurality of data points; and determining, based on the at least one seed point and a distance threshold, the plurality of initial control points from the plurality of data points.

In some embodiments, the distance threshold is related to a distance between two regions of interest (ROIs) in the first image.

In some embodiments, the dividing the first image into at least two sub-regions may include dividing the first image to obtain the at least two sub-regions based on at least one of the one or more features of the plurality of initial control points.

In some embodiments, the dividing the first image into at least two sub-regions includes extracting a region of interest (ROI) of the first image; and dividing the ROI of the first image to obtain the at least two sub-regions.

In some embodiments, the determining, based on one or more features of the plurality of initial control points, one or more target control points in each of the at least two sub-regions may include determining, based on the one or more features of the plurality of initial control points, a weight of the each of the at least two sub-regions; and determining, based on the weight of the each of the at least two sub-regions and the plurality of initial control points, the one or more target control points in the each of the at least two sub-regions.

In some embodiments, the determining, based on the one or more features of the plurality of initial control points, a weight of the each of the at least two sub-regions may include determining, based on the one or more features of the plurality of initial control points, an order of the at least two sub-regions; and determining, based on the order, the weight of the each of the at least two sub-regions.

In some embodiments, the determining, based on the one or more features of the plurality of initial control points, an order of the at least two sub-regions may include determining, based on at least one of gradient values of one or more initial control points in the each of the at least two sub-regions or a count of the one or more initial control points in the each of the at least two sub-regions, the order of the at least two sub-regions.

In some embodiments, the determining, based on at least one of gradient values of one or more initial control points in the each of the at least two sub-regions or a count of the one or more initial control points in the each of the at least two sub-regions, the order of the at least two sub-regions may include dividing the each of the at least two sub-regions into at least two blocks; and determining, based on at least one of a maximum gradient value of each of the at least two blocks of the each of the at least two sub-regions or a count of initial control points in the each of the at least two blocks, the order of the at least two sub-regions.

In some embodiments, the determining, based on at least one of a maximum gradient value of each of the at least two blocks of the each of the at least two sub-regions or a count of initial control points in the each of the at least two blocks, the order of the at least two sub-regions may include: for the each of the at least two sub-regions, determining at least one of a sum of maximum gradient values of the at least two blocks, a sum of counts of initial control points in the at least two blocks, a maximum of the maximum gradient values of the at least two blocks, or a maximum of the counts of initial control points in the at least two blocks; and determining, based on the at least one of the sum of maximum gradient values of the at least two blocks, the sum of counts of initial control points in the at least two blocks, the maximum of the maximum gradient values of the at least two blocks, or the maximum of the counts of initial control points in the at least two blocks, the order of the at least two sub-regions.

In some embodiments, the determining, based on the weight of the each of the at least two sub-regions and the plurality of initial control points, the one or more target control points in the each of the at least two sub-regions may include determining, based on the weight, a count of target control points in the each of the at least two sub-regions; and determining the one or more target control points in the each of the at least two sub-regions by performing a threshold-based selection on at least one of gray values of the initial control points in the each of the at least two sub-regions, gradient values of the initial control points of the each of the at least two sub-regions, or maximum gradient values of initial control points in the each of the at least two blocks in the each of the at least two sub-regions.

In some embodiments, the determining, based on the order, the weight of the each of the at least two sub-regions may include assigning a greater weight to a high-ranked sub-region of the at least two sub-regions compared with a low-ranked sub-region of the at least two sub-regions.

In some embodiments, the method may further include obtaining a second image; generating a registering result by registering the first image to the second image based on the one or more target control points to obtain a registered first image; and determining, based on the registering result, an image of an object of interest in the second image.

In some embodiments, the first image may include a mask, and the second image may include an angiogram.

In some embodiments, the method further comprising: obtaining a second image; obtaining, in the second image, one or more control points corresponding to the one or more target control points in the first image; generating a registering result based on the one or more target control points in the first image and the one or more corresponding control points in the second image; obtaining a registered first image by performing, based on the registration result, a pixel displacement on the first image to align structures of the first image with corresponding structures of the second image; determining an image of an object of interest in the second image based on the second image and the registered first image.

Another aspect of the present disclosure provides a system for determining an image control point. The system may include at least one storage device storing a set of instructions; and at least one processor in communication with the storage device, wherein when executing the set of instructions, the at least one processor may be configured to cause the system to perform operations of the method for determining an image control point.

Another aspect of the present disclosure provides a system for determining an image control point. The system may include an image acquisition module, an initial control point determination module, a sub-region determination module, and a target control point determination module. The image acquisition module may be configured to obtain a first image; the initial control point determination module may be configured to determine a plurality of initial control points in the first image; the sub-region determination module may be configured to divide the first image into at least two sub-regions; and the target control point determination module may be configured to determine, based on one or more features of the plurality of initial control points, one or more target control points in each of the at least two sub-regions.

Another aspect of the present disclosure provides a non-transitory computer readable medium storing instructions, the instructions, when executed by at least one processor, causing the at least one processor to implement the method for determining an image control point.

### BRIEF DESCRIPTION OF THE DRAWINGS

The present disclosure is further illustrated in terms of exemplary embodiments, and these exemplary embodiments are described in detail with reference to the drawings. These embodiments are not restrictive. In these embodiments, the same number indicates the same structure, wherein:

FIG. 1 is a schematic diagram illustrating an exemplary system for determining an image control point according to some embodiments of the present disclosure;

FIG. 2 is a block diagram illustrating an exemplary system for determining an image control point according to some embodiments of the present disclosure;

FIG. 3 is a flowchart illustrating an exemplary process for determining an image control point according to some embodiments of the present disclosure;

FIG. 4 is a schematic diagram illustrating an exemplary process for determining an image control point according to some embodiments of the present disclosure; and

FIG. 5 is another schematic diagram illustrating an exemplary process for determining an image control point according to some embodiments of the present disclosure.

### DETAILED DESCRIPTION

In order to illustrate the technical solutions related to the embodiments of the present disclosure, a brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

It will be understood that the terms “system,” “device,” “unit,” and/or “module” used herein are one method to distinguish different components, elements, parts, sections, or assemblies of different levels in ascending order. However, the terms may be displaced by other expressions if they may achieve the same purpose.

As shown in the present disclosure and claims, unless the context clearly indicates exceptions, the words “a,” “an,” “one,” and/or “the” do not specifically refer to the singular, but may also include the plural. The terms “including” and “comprising” only suggest that the steps and elements that have been clearly identified are included, and these steps and elements do not constitute an exclusive list, and the method or device may also include other steps or elements.

The flowcharts used in the present disclosure may illustrate operations executed by the system according to embodiments in the present disclosure. It should be understood that a previous operation or a subsequent operation of the flowcharts may not be accurately implemented in order. Conversely, various operations may be performed in inverted order, or simultaneously. Moreover, other operations may be added to the flowcharts, and one or more operations may be removed from the flowcharts.

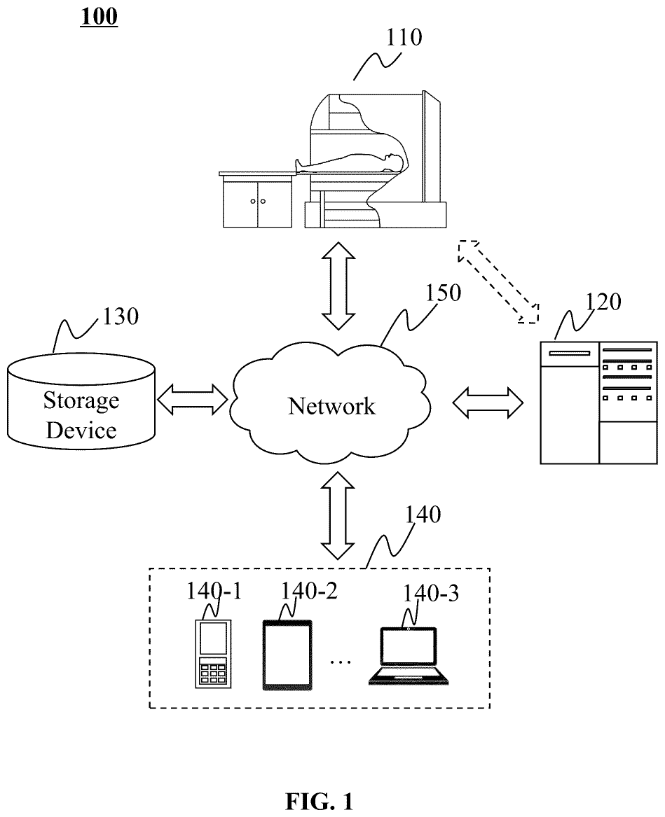

FIG. 1 is a schematic diagram illustrating an exemplary system for determining an image control point according to some embodiments of the present disclosure.

In the present disclosure, the system 100 for determining an image control point in FIG. 1 is referred to as the system 100. As shown in FIG. 1, in some embodiments, the system 100 may include a medical imaging device 110, a processing device 120, a storage device 130, a terminal 140, and a network 150.

The medical imaging device 110 refers to a device that uses different media to reproduce internal structures of a human body as an image. In some embodiments, the medical imaging device 110 may include various of medical imaging devices, a digital subtraction angiography (DSA) device, a computed radiography (CR) system, a digital radiography (DR) system, a computed tomography (CT) system, a magnetic resonance imaging (MRI) system, etc. The medical imaging device 110 provided above is merely for illustrative purposes, which may not be limited herein. In some embodiments, the medical imaging device 110 may acquire an image (e.g., an angiogram, a mask, etc.) of an object (e.g., a patient) and send the image to the processing device 120. In some embodiments, the image acquired by the medical imaging device 110 may be stored in the storage device 130. The medical imaging device 110 may receive a command sent by a doctor via the terminal 140, and perform a relevant operation according to the command, such as an irradiation imaging operation, etc. In some embodiments, the medical imaging device 110 may exchange data and/or information with other components in the system 100 (e.g., the processing device 120, the storage device 130, and the terminal 140) via the network 150. In some embodiments, the medical imaging device 110 may be directly connected to other components in the system 100. In some embodiments, one or more components of the system 100 (e.g., the processing device 120, the storage device 130) may be included in the medical imaging device 110.

The processing device 120 may process data and/or information obtained from other devices or one or more components of the system, and execute a method for determining an image control point shown in some embodiments of the present disclosure based on the data, information and/or a processing result to complete one or more functions described in some embodiments of the present disclosure. For example, the processing device 120 may acquire an image control point based on the image (e. g., a mask) of the object acquired by the medical imaging device 110. For example, the processing device 120 may obtain an image related to vascular information of the object by subtracting the angiogram and the mask based on the image control point. In some embodiments, the processing device 120 may send the data obtained during processing, such as control point gradient information, image segmentation and/or partitioning, region sorting results, etc., to the storage device 130 for storage. In some embodiments, the processing device 120 may obtain pre-stored data and/or information from the storage device 130, such as images of the object, processing algorithms, etc., for performing the method of determining the image control point shown in some embodiments of the present disclosure, such as determining a target control point.

In some embodiments, the processing device 120 may include one or more sub-processing devices (e.g., aa single core processing device or a multi-core processing device). Merely by way of example, the processing device 120 may include a central processing unit (CPU), an application specific integrated circuit (ASIC), an application specific instruction set processor (ASIP), a graphics processing unit (GPU), a peripheral processing unit (PPU), a digital signal processor (DSP), a field programmable gate array (FPGA), a programmable logic circuit (PLD), a controller, a microcontroller unit, a reduced instruction set computer (RISC), a microprocessor, or any combination thereof.

The storage device 130 may store data or information generated by other devices. In some embodiments, the storage device 130 may store data and/or information obtained from the medical imaging device 110, such as a mask, an angiogram, or the like. In some embodiments, the storage device 130 may store data and/or information processed by processing device 120, such as control point information, vascular information images, etc. The storage device 130 may include one or more storage components, each of which may be an independent device or a part of other devices. The storage device may be local or implemented via the cloud.

The terminal 140 may control an operation of the medical imaging device 110. The doctor may issue an operation instruction to the medical imaging device 110 via the terminal 140, so that the medical imaging device 110 may complete a corresponding operation, for example, irradiating a patient's designated body part for imaging. In some embodiments, the terminal 140 may instruct processing device 120 to execute the method for determining the image control points as shown in some embodiments of the present disclosure. In some embodiments, the terminal 140 may receive a patient vascular information image from the processing device 120, and the doctor may obtain accurate patient vascular information for effective and targeted examination and/or treatment of the patient. In some embodiments, the terminal 140 may be one or any combination of other devices with input and/or output functions, such as a mobile device 140-1, a tablet computer 140-2, a laptop computer 140-3, a desktop computer, etc.

The network 150 may connect various components of the system and/or connect the system with external resource parts. The network 150 may enable a communication between various components with other parts outside the system, promoting the exchange of data and/or information. In some embodiments, one or more components of the system 100 (e.g., the medical imaging device 110, the processing device 120, the storage device 130, and the terminal 140) may send data and/or information to other components via the network 150. In some embodiments, the network 150 may be a wired or wireless network, or any combination thereof.

It should be noted that the above description is provided for illustrative purposes only and may not be intended to limit the scope of the present disclosure. For those skills in the art, various changes and modifications may be made under the guidance of the content of the present disclosure. The features, structures, methods, and other features of the exemplary embodiments described in the present disclosure may be combined in various ways to obtain additional and/or alternative exemplary embodiments. For example, the processing device 120 may be operated based on a cloud computing platform, such as a public cloud, a private cloud, a community cloud, a hybrid cloud, or the like. However, these changes and modifications may not deviate from the scope of the present disclosure.

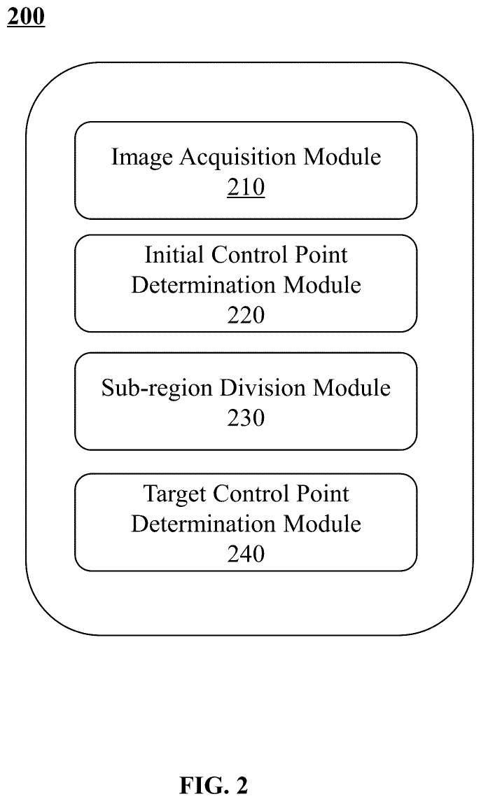

FIG. 2 is a block diagram illustrating an exemplary system for determining an image control point according to some embodiments of the present disclosure.

As shown in FIG. 2, in some embodiments, the system 200 for determining an image control point may include an image acquisition module 210, an initial control point determination module 220, a sub-region division module 230, and a target control point determination module 240. In some embodiments, each module in the system 200 may be implemented by the processing device 120.

In some embodiments, the image acquisition module 210 may be used to obtain a first image, wherein the first image may include a mask. The mask refers to an image that does not include vascular information, for example, an image that includes only body tissue without contrast agent.

In some embodiments, the image acquisition module 210 may also be used to obtain a second image, wherein the second image may include an angiogram. The angiogram refers to an image including vascular information, such as an image with the contrast agent.

In some embodiments, the initial control point determination module 220 may be used to determine a plurality of initial control points in the first image.

In some embodiments, the initial control point determination module 220 may use an edge detection algorithm to extract the plurality of initial control points in the first image.

In some embodiments, the initial control point determination module 220 may extract feature values of a plurality of data points of the first image; select at least one seed point from the plurality of data points based on the feature values of the plurality of data points; and determine the plurality of initial control points from the plurality of data points based on the at least one seed point and a distance threshold. The distance threshold may be related to a distance between two regions of interest (ROIs) in the first image.

In some embodiments, the sub-region division module 230 may be used to divide the first image into at least two sub-regions.

In some embodiments, the sub-region division module 230 may divide the first image to obtain the at least two sub-regions based on at least one of one or more features of the plurality of initial control points.

In some embodiments, the sub-region division module 230 may extract the ROI of the first image, and divide the ROI of the first image to obtain the at least two sub-regions.

In some embodiments, the target control point determination module 240 may be used to determine one or more target control points in each of the at least two sub-regions based on the one or more features of the plurality of initial control points.

In some embodiments, the target control point determination module 240 may determine a weight of the each of the at least two sub-regions based on the one or more features of the plurality of initial control points.

In some embodiments, the target control point determination module 240 may determine an order of the at least two sub-regions based on the one or more features of the plurality of initial control points.

In some embodiments, the target control point determination module 240 may determine the order of the at least two sub-regions based on at least one of gradient values of one or more initial control points in the each of the at least two sub-regions or a count of the one or more initial control points in the each of the at least two sub-regions. The order may refer to an ordering result by ordering the at least two sub-regions.

In some embodiments, the target control point determination module 240 may divide the each of the at least two sub-regions into at least two blocks; and determine the order of the at least two sub-regions based on at least one of a maximum gradient value of each of the at least two blocks of the each of the at least two sub-regions or a count of initial control points in the each of the at least two blocks.

In some embodiments, the target control point determination module 240 may determine, for the each of the at least two sub-regions, at least one of a sum of maximum gradient values of the at least two blocks, a sum of counts of initial control points in the at least two blocks, a maximum of the maximum gradient values of the at least two blocks, or a maximum of the counts of initial control points in the at least two blocks; and determine the order of the at least two sub-regions based on the at least one of the sum of maximum gradient values of the at least two blocks, the sum of counts of initial control points in the at least two blocks, the maximum of the maximum gradient values of the at least two blocks, or the maximum of the counts of initial control points in the at least two blocks.

In some embodiments, the target control point determination module 240 may determine the weight of the each of the at least two sub-regions based on the order. The weight of the each of the at least two sub-regions may refer to a weight obtained in a unit of a sub-region.

In some embodiments, the target control point determination module 240 may assign a greater weight to a high-ranked sub-region of the at least two sub-regions compared with a low-ranked sub-region of the at least two sub-regions.

In some embodiments, the target control point determination module 240 may the one or more target control points in the each of the at least two sub-regions based on the weight of the each of the at least two sub-regions and the plurality of initial control points.

In some embodiments, the target control point determination module 240 may determine a count of target control points in the each of the at least two sub-regions based on the weight; and determine the one or more target control points in the each of the at least two sub-regions by performing a threshold-based selection on at least one of gray values of the initial control points in the each of the at least two sub-regions, gradient values of the initial control points of the each of the at least two sub-regions, or maximum gradient values of initial control points in the each of the at least two blocks in the each of the at least two sub-regions.

In some embodiments, the system 200 may also include an image overlay module (not shown). The image overlay module may be used to generate a registering result by registering the first image to the second image based on the one or more target control points to obtain a registered first image; and determine an image of an object of interest (e.g., a target image) in the second image based on the registering result. In some embodiments, the target image may include a vascular information image, which eliminate motion artifacts and may reflect clear and distinct vascular information of the object.

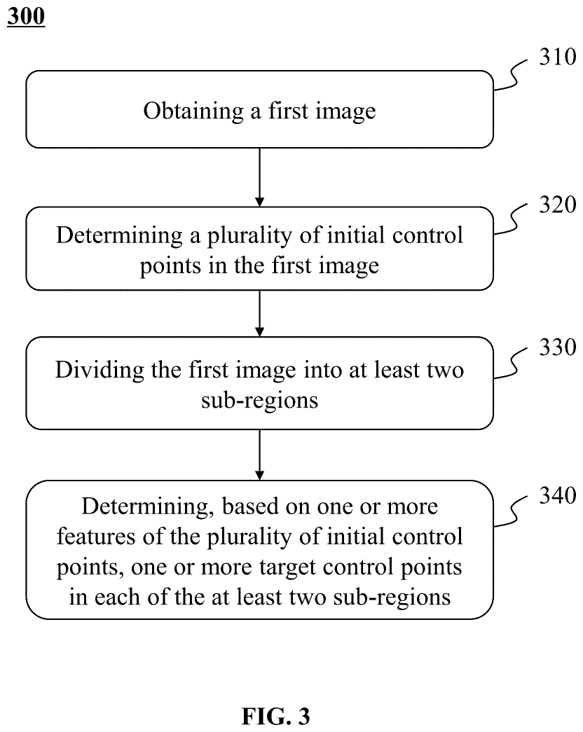

FIG. 3 is a flowchart illustrating an exemplary process for determining an image control point according to some embodiments of the present disclosure.

As shown in FIG. 3, in some embodiments, process 300 may include the following operations. In some embodiments, process 300 may be executed by the processing device 120.

In 310, a first image may be obtained. In some embodiments, operation 310 may be performed by the image acquisition module 210.

The first image refers to an image that does not include vascular information, such as an organ/tissue image without contrast agent. A second image refers to an image including vascular information, such as organ/tissue images including contrast agents, or an image obtained by other ways including vascular information, etc.

In some embodiments, the processing device 120 may obtain the first image and/or the second image of an object (e.g., a patient) by scanning the object using a medical imaging device (e.g., a DSA, etc.). The first image may be a scanning image of a body region of the object including organs/tissues of blood vessels obtained without using contrast agent, and the second image may be a scanning image of the object using contrast agents on the same body region as the first image. That is, when obtaining the first image and the second image, a scanning position for the first image and the second image on the object may be the same. In some embodiments, the processing device 120 may also obtain the first image and/or the second image from a storage device or the like. Between the first image and the second image obtained by scanning the object, a displacement of the object may exist due to a spontaneous internal motion and a possible external motion of the object, resulting in motion artifacts (also known as motion structure artifacts) in the first image and/or the second image. In some embodiments, the processing device 120 may eliminate the motion artifacts and obtain a vascular information image by performing a pixel displacement on the first image and/or the second image, and overlaying (e.g., subtracting) one of the first image and the second image with another of the first image and the second image.

In 320, a plurality of initial control points in the first image may be determined. In some embodiments, operation 320 may be performed by the initial control point determination module 220.

A control point refers to a data point related to a structural distribution of the object in a medical image, such as an organ/tissue boundary point, or other points that can represent the structural distribution, etc. The data point may include a pixel point in a two-dimensional (2D) image, a voxel point in a three-dimensional (3D) image, or the like. In some embodiments, the plurality of initial control points may include a plurality of control points determined based on a structural distribution of the first image. In some embodiments, the processing device 120 may determine a control point in the second image whose position corresponding to a position of an initial control point in the first image. In some embodiments, the processing device 120 may overlay the first image and the second image based on one or more target control points selected from the plurality of initial control points. In some embodiments, the processing device 120 may determine the plurality of initial control points in the first image using various methods, such as an edge detection algorithm, a random selection, etc.

In some embodiments, the processing device 120 may use the edge detection algorithm (e.g., a gradient algorithm, a canny operator algorithm, a first-order differential edge operator algorithm, a Roberts operator algorithm, etc.) to extract structural information of the first image. The structural information may include contour information of organs/tissues, etc. The plurality of initial control points of the first image may be extracted based on the structural information. For example, a large number of control points at a contour boundary/edge of organs/tissues may be randomly or equidistantly determined as an initial control point. In some embodiments, a count of the plurality of initial control points may be greater than or equal to a threshold, for example, greater than or equal to 100, 200, 1000, etc.

Due to a significant grayscale difference in a structural edge region of an image, using a method of difference in the structural edge region may further enhance and highlight information in the structural edge region. In addition, in a vascular subtraction application, performing subtraction between the angiogram and the mask may present a strong visual difference in the structural edge region, which means the structural edge region is highly susceptible to artifacts. Therefore, the larger the gradient values of a region are, the richer the structure information included in the region is, and the easier the region is to include artifacts. In some embodiments, the processing device 120 may determine an importance of a region based on gradient values of initial control points or a count of initial control points for determination of the one or more target control points.

In some embodiments, when determining the initial control points of the first image, the processing device 120 may use a gradient extraction algorithm to extract a region with rich structure information in the image, and select the initial control points from data points in the region. Specifically, obtained image data may indicate that the grayscale variation of a region with a relatively obvious structure may be relatively great, e.g., a gradient of the region may be relatively great. The processing device 120 may determine a grayscale gradient of an image based on a mean square of a horizontal difference in the image and a vertical difference in the image, or a mean square of differences on eight directions of the image (e.g., 0 degrees, 45 degrees, 90 degrees, 135 degrees, 180 degrees, 225 degrees, 270 degrees, and 315 degrees). The processing device 120 may divide the image into blocks based on a preset value. In each block, data points with gradient values greater than or equal to a preset threshold may be selected as the initial control points. The preset threshold may include a local maximum gradient of a certain region (e.g., a structural edge region) in the image.

In 330, the first image may be divided into at least two sub-regions. In some embodiments, operation 330 may be performed by the sub-region division module 230.

In some embodiments, the processing device 120 may divide the first image into the at least two sub-regions based on a predetermined count of regions. For example, if the count of regions is fixed to M*M, and M may be a natural number greater than 1, such as 2, 3, 4, 5, 6, 7, 8, etc. In some embodiments, a count of sub-regions in the first image can be determined based on the count of the plurality of initial control points in the first image. For example, each of the at least two sub-regions includes an initial control point, and the count of the at least two sub-regions may be equal to the count of the plurality of initial control points.

In some embodiments, one of the at least two sub-regions may include at least two image blocks (also referred to as blocks). In some implementations, a shape of one of the at least two blocks may be, e.g., a square, a rectangle, a triangle, a circle, an irregular shape, etc., which is not limited in the present disclosure. In some embodiments, sizes of the at least two blocks may be the same.

In some embodiments, the processing device 120 may also divide the first image into sub-regions based on other rules, such as a certain sub-region or each sub-region including a preset count of data points, a certain sub-region or each sub-region including a preset count of initial control points, etc.

In some embodiments, all sub-regions in the first image may have the same or different sizes. Shapes of all sub-regions may be the same or different. In some embodiments, the shapes of all sub-regions in the first image may be various shapes, such as squares, rectangles, polygons, etc.

In some embodiments, the processing device 120 may divide the first image to obtain at least two sub-regions based on at least one of the one or more features of the plurality of initial control points.

The one or more features of the plurality of initial control points refer to information that can distinguish the plurality of initial control points, such as distribution features of the plurality of initial control points, structural features of scanning parts, and feature values of the plurality of initial control points. In some embodiments, the processing device 120 may determine a size and a distribution of the at least two sub-regions based on the distribution features of the plurality of initial control points. Sizes of the at least two sub-regions may be different. For example, a region with a relatively dense distribution of initial control points may be divided into a plurality of sub-regions that have relatively small sizes and/or a relatively dense distribution, while a region with a relatively sparse distribution of initial control points may be divided into a plurality of sub-regions that have relatively large sizes and/or a relatively sparse distribution. By determining the sub-regions based on the distribution of the plurality of initial control points, the selection of one or more target control points may be more accurate.

In some embodiments, the processing device 120 may determine the at least two sub-regions based on different scanning positions. In some embodiments, the processing device 120 may determine the at least two sub-regions based on importance of the scanning positions. For example, for important parts such as organs/tissues of concern (e.g., an aorta), the at least two sub-regions may be smaller and/or may be distributed more densely. For non-important parts (e.g., tissues without blood vessels) that are not of concern or have less attention, the at least two sub-regions may be larger and/or may be distributed more sparsely. By determining the at least two sub-regions in this way, the accuracy of selection of the one or more target control points may be improved.

A region of interest (ROI) refers to a region of user attention, such as organs/tissues suspected of having lesions, organs/tissues with high risk of lesions, etc. In some embodiments, the ROI may include any region designated by a user. In some embodiments, the ROI may be included in a sub-region, and the processing device 120 may determine at least one ROI in any of the at least two sub-regions. In some embodiments, the processing device 120 may determine the ROI before performing a region division.

In some embodiments, the processing device 120 may perform the region division in a region (e.g., an ROI) that includes effective information. In some embodiments, the processing device 120 may extract an ROI of the first image and divide the ROI in any of the aforementioned ways to obtain the at least two sub-regions. For regions other than the ROI, the region division may not need to be performed. By using this method of region division, unnecessary region division is avoided, workload is reduced, and the efficiency of region division is improved.

In some embodiments, operation 320 may be executed before operation 330. In some embodiments, operation 320 may be executed simultaneously with operation 330. In some embodiments, operation 320 may be performed after operation 330, for example, after dividing the first image into at least two sub-regions, the processing device 120 may determine the plurality of initial control points of the first image based on the at least two sub-regions.

In some embodiments, the processing device 120 may extract feature values of each of a plurality of data points in the first image. The feature values reflect importance and representativeness of the plurality of data points, such as whether they are boundary points, center points, and other points that can identify a size and position of organs/tissues. For example, the feature values of the plurality of data points located at the boundaries and centers of organs/tissues may be larger than the feature values of other portions of data points in other positions. In some embodiments, the processing device 120 may extract feature values of the plurality of pixels in specific regions (e.g., the at least two sub-regions, the ROIs, etc.) in the first image. In some embodiments, the feature values of the plurality of data points may be obtained through various methods such as a machine learning model or a preset algorithm. In some embodiments, an edge extraction algorithm and/or an algorithm based on machine learning may be used to identify the boundaries of organs/tissues. larger feature values may be assigned to the data points on the identified boundaries of organs/tissues, and smaller feature values may be assigned to the data points in other positions. In some embodiments, a center of the organ/tissue may be further determined based on the identified boundaries. larger feature values may be assigned to the data points on the identified boundaries of organ/tissue and the determined center position of the organ/tissue, and smaller feature values may be assigned to the data points in other positions.

In some embodiments, the processing device 120 may select at least one seed point from the plurality of data points. For example, the data points with the feature values greater than or equal to a threshold may be determined as the at least one seed point. For example, the processing device 120 may order the data points based on corresponding feature values from largest to smallest, and take a preset count of data points in front as the at least one seed point. The at least one seed point may be at least one representative point that can reflect features of body structures (e.g., the sizes and position of organs/tissues) of the object. For example, the at least one seed point may be located at contour boundaries/edges of the organs/tissues, or at centers of organs/tissues, etc. For example, the at least one seed point may be selected for each organ/tissue, etc. For example, the at least one seed point may be selected in a preset ROI. In some embodiments, the processing device 120 may directly determine at least one of data points at the boundary and center of organs/tissues as the at least one seed point. For example, the edge extraction algorithms may be used to identify the boundaries of the organs/tissues, and the data points on the boundaries of the organs/tissues may be determined as the at least one seed point. For example, the edge extraction algorithms may be used to identify the boundaries of the organs/tissues, and the centers of the organs/tissues may be determined based on the boundaries, and the data points on the center positions of the organs/tissues, and/or the data points on the boundaries of the organs/tissues, may be determined as the at least one seed point.

In some embodiments, the processing device 120 may provide a minimum distance for two ROIs in a sub-region, for example, a distance between the two ROIs may be greater than or equal to the minimum distance. The plurality of initial control points in the ROIs may be determined. The ROIs may be located at different sub-regions or within the same sub-region. The plurality of initial control points selected through the method makes the distribution of the plurality of initial control points more uniform, and with some emphasis. In the present disclosure, a distance between two regions may be the minimum of distances between any two data points located in the two regions. For example, if there are a point P_{A} in region A and a point P_{B} in region B, and the distance between the two points is P_{AB}, then if both P_{A} and P_{B} are arbitrarily selected, there may be multiple values of P_{AB}. When P_{AB} takes a minimum value of the multiple values, the P_{AB} may be designated as a distance D_{AB} between the two regions.

In some embodiments, the processing device 120 may determine the plurality of initial control points from the plurality of data points in the first image based on the at least one seed point and a distance threshold. In some embodiments, the processing device 120 may select an ROI (e.g., any region in an upper left corner, lower right corner, etc., of the first image) on the first image based on a user selection or a preset rule, and then at least one seed point may be determined within the ROI. A data point that a distance between the data point and the at least one seed point is not less than the distance threshold may be determined as an initial control point.

In some embodiments, the distance threshold may be related to a distance between two ROIs in the first image. For example, if the two ROIs are region A and region B, and the distance between the two ROIs is D_{AB}, and if a seed point P_{A} is first determined in region A, any data point that is outside of region A (clearly including region B) and is not less than D_{AB} from P_{A} may be determined as an initial control point. In some embodiments, the two ROIs may be located at different sub-regions or in the same sub-region. The initial control points selected by this method ensures that as many locations as possible are served as the selection region for control points, avoiding the omission of important regions.

In some embodiments, for the same image, the processing device 120 may use different methods to determine a plurality of control points separately, and obtain the plurality of initial control points based on the plurality of control points to. For example, the processing device 120 may determine at least two control point groups using different methods, and take a union of the at least two control point groups as a group of the plurality of initial control points.

In 340, one or more target control points in each of the at least two sub-regions may be determined based on one or more features of the plurality of initial control points. In some embodiments, operation 340 may be executed by the target control point determination module 240.

The one or more target control points refer to one or more control points in the first image used for overlaying the first image with the second image. In some embodiments, the processing device 120 may determine one or more target control points in each of the at least two sub-regions in the first image from the plurality of initial control points in the first image based on one or more features (e.g., a distribution feature of the plurality of initial control points, a structural feature of the scanning region, the feature values of the plurality of initial control points, etc.) of the plurality of initial control points.

In some embodiments, the processing device 120 may determine a weight of each of the at least two sub-regions based on the distribution feature of the plurality of initial control points (e.g., a count of one or more initial control points in different sub-regions). In some embodiments, the processing device 120 may order all sub-regions in the first image. For example, the first image includes four sub-regions: sub-region 1, sub-region 2, sub-region 3, and sub-region 4. After the four sub-regions are ordered, an order of the four sub-regions may be: sub-region 2, sub-region 3, sub-region 1, and sub-region 4.

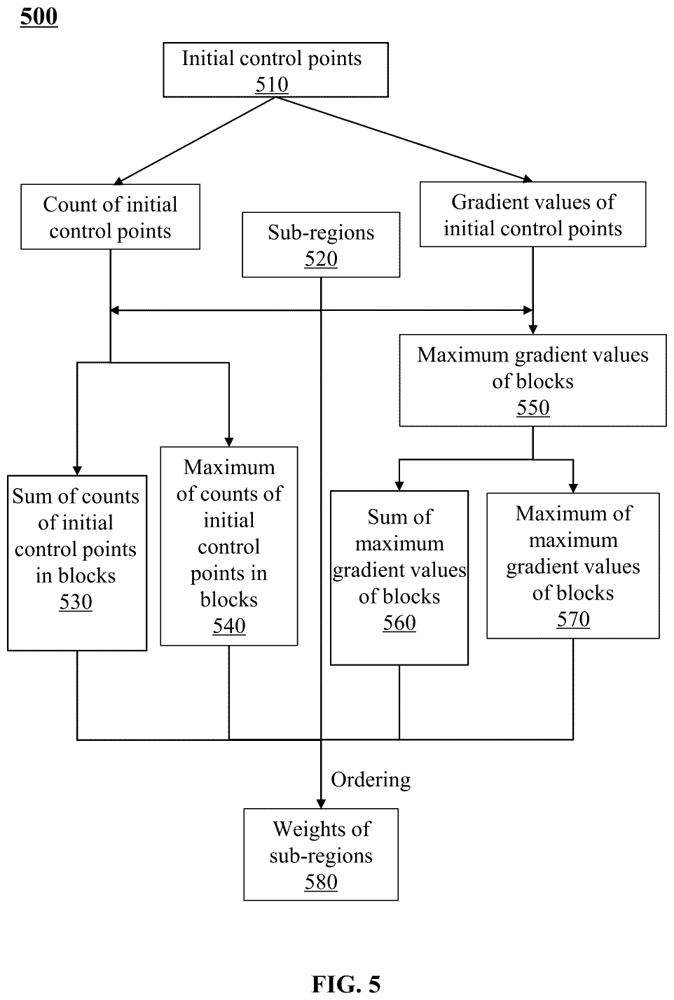

In some embodiments, the processing device 120 may determine the order of the at least two sub-regions based on relevant feature information of the at least two sub-regions, such as gradient values of initial control points in each of the at least two the sub-regions, a count of initial control points in each of the at least two sub-regions, etc. More information on how to determine the order of the at least two sub-regions based on the relevant feature information of the at least two sub-regions may be found elsewhere in the present disclosure, for example, FIG. 5 and the relevant description, which may not be repeated herein.

In some embodiments, the processing device 120 may determine a weight of the each of the at least two sub-regions based on the order of the at least two sub-regions mentioned above. For example, weights of the at least two sub-regions may be assigned in descending order based on the order of the at least two sub-regions. For example, the processing device 120 may divide every two adjacent sub-regions into a group based on the order of the at least two sub-regions, and the sub-regions in the same group may have the same weight.

In some embodiments, the weight of a sub-region may represent a count of target control points in the sub-region. For example, if the weight of sub-region 1 is 36, it means that sub-region 1 needs to include 36 target control points. In some embodiments, a sum of the weights of all sub-regions may be a count of the one or more target control points in the first image. For example, if the first image includes 200 target control points, the sum of weights assigned to all sub-regions in the first image may also be 200.

In some embodiments, the processing device 120 may assign a greater weight to the top sub-region in the order of the at least two sub-regions than a weight of a sub-region in the bottom of the order. For example, the sub-regions arranged in order are: sub-region 2, sub-region 3, sub-region 1, and sub-region 4. The weights assigned to sub-regions 1, 2, 3, and 4 may be W1, W2, W3, and W4, respectively. Therefore, W2>W3>W1>W4. In some embodiments, the weights of adjacent sub-regions in the order may be equal, but the weights of all sub-regions may not be equal. For example, W2=W3, but W1, W2, W3, and W4 may not all be equal.

In some embodiments, ordering the at least two sub-regions and/or determining weights of the at least two sub-regions in the first image may be performed based on a machine learning model (e.g., a convolutional neural network (CNN) model, a recurrent-neural networks (RNN), etc.). An input of the machine learning model may be the first image that has been divided into at least two sub-regions, and the output of the machine learning model may be the order and/or weights of the at least two sub-regions.

In some embodiments of the present disclosure, by ordering the at least two sub-regions in the image based on gradient values, the count of target control points, etc., an ordering result is more reasonable, and better reflects features of the at least two sub-regions. By assigning weights to the at least two sub-regions based on the order (i.e., the ordering result), the weights of the at least two sub-regions better reflect corresponding importance in the image processing, and different sub-regions are distinguished based on the corresponding importance.

In some embodiments, the processing device 120 may determine the one or more target control points in each of the at least two sub-regions from the plurality of initial control points of the first image based on the weight of the each of the at least two sub-regions and the plurality of initial control points.

In some embodiments, the processing device 120 may determine a count of the one or more target control points in each of the at least two sub-regions based on the weight of the each of the at least two sub-regions. Specifically, the count of the one or more target control points may be assigned to each of the at least two sub-regions, and a count of the one or more target control points in a sub-region with a larger weight may be greater than or equal to a count of the one or more target control points in a sub-region with a smaller weight. For example, if the weights of sub-regions 1, 2, 3, and 4 are W1, W2, W3, and W4, respectively, and W2>W3>W1>W4, the counts of the one or more target control points in the four sub-regions 1, 2, 3, and 4 may be denoted as C1, C2, C3, and C4, then C2≥C3≥C1≥C4.

In some embodiments, a weight of a sub-region may be greater than or equal to a count of the one or more target control points in the sub-region. For example, if the weight of sub-region 1 is 36, the count of the one or more target control points in sub-region 1 may be less than or equal to 36.

In some embodiments, the processing device 120 may determine a total number of target control points in the first image based on the count of the plurality of initial control points in the first image, and allocate the count of the one or more target control points in each of the at least two sub-regions based on a proportion of the weight of each of the at least two sub-regions to a total weight of all sub-regions. In some embodiments, a proportion of the one or more target control points in a sub-region to the total number of the target control points in the first image may be equal to the proportion of the weight of the corresponding sub-region to the total weight of all sub-regions. For example, in the first image, the count of initial control points C is 1000, the total weight Wall of all sub-regions (i.e., the sum of weights of all sub-regions in the first image) is 20, the weight W1 of sub-region 1 is 4 (accounting for ⅕ of the total weight), the weight W2 of sub-region 2 is 7 (accounting for 7/20 of the total weight), the weight W3 of sub-region 3 is 6 (accounting for 3/10 of the total weight), and the weight W4 of sub-region 4 is 3 (accounting for 3/20 of the total weight). If the total number of target control points in the first image is determined to be 1/10 of the count of the plurality of initial control points C, that is, Cₐₗₗ=100, then the count of the one or more target control points C₁ in sub-region 1 is 100*⅕=20, the count of the one or more target control points C2 in sub-region 2 is 100* 7/20=35, the count of the one or more target control points C3 in sub-region 3 is 100* 3/10=30, and the count of the one or more target control points C₄ in sub-region 4 is 100* 3/20=15.

In some embodiments, the processing device 120 may adjust the count of the one or more target control points in each of the at least two sub-regions based on a preset rule. The preset rule may include: a rule that there is at least one target control point in each of the at least two sub-regions (ensuring that there is a target control point in each sub-region), a rule that the count of the one or more target control points in each of the at least two sub-regions is less than a threshold (preventing an excessive count of the one or more target control points in a sub-region), a rule that the sum of counts of target control points in all sub-regions is less than or equal to a threshold (preventing the total number of target control points in the image from being too large), or any combination thereof.

In some embodiments, the processing device 120 may filter feature values in each of the at least two sub-regions based on a threshold to determine the one or more target control points in each of the at least two sub-regions. The feature values in a sub-region may include one or any combination of grayscale values of the one or more initial control point in the sub-region, gradient values of the initial control points of the each of the at least two sub-regions, and maximum gradient values of initial control points in the each of the at least two blocks in the each of the at least two sub-regions.

In some embodiments, the processing device 120 may order the at least two blocks and/or the one or more initial control points in one of the at least two sub-regions based on the in each of the at least two sub-regions, and determine the one or more target control points in each of the at least two sub-regions based on the ordering result and the count of the one or more target control points in each of the at least two sub-regions.

In some embodiments, the feature values in each of the at least two sub-regions may be the gradient values of the initial control points of the each of the at least two sub-regions. For each of the at least two sub-regions, the processing device 120 may order all initial control points in the sub-region based on the gradient values of the initial control points, determine a gradient threshold based on a proportion of the count of the one or more target control points in the sub-region to a count of the one or more initial control points in the sub-region, and determine the initial control points within the gradient threshold as the one or more target control points in the sub-region. The count of the one or more target control points may be the same as a value of the count of the one or more target control points assigned to the sub-region. For example, the count of the one or more target control points C₁ in sub-region 1 of the first image is 30. If the count of the one or more initial control points in sub-region 1 is 300, the proportion of the count of the one or more target control points in sub-region 1 to the count of the one or more initial control points is 30/300*100%=10%. The processing device 120 may determine the gradient value of the 30th initial control point whose gradient value is ranked from the largest to the smallest in the sub-region 1 as the gradient threshold, and determine the initial control points whose gradient values are greater than or equal to the gradient threshold in the sub-region 1 as the target control point of the sub-region 1. The count of the target control points may be equal to 30.

In some embodiments, for each sub-region, the processing device 120 may directly determine at least one initial control point with a larger gradient value in the sub-region as at least one target control point, where the count of the one or more target control points may be equal to the count of the one or more target control points allocated to the sub-region. For example, the count of the one or more target control points C₁ in sub-region 1 in the first image is 25. The processing device 120 may order the initial control points in sub-region 1 in a descending order of gradient values, and determine the top 25 initial control points as the target control points in sub-region 1.

In some embodiments, one of the feature values in the sub-region may be the maximum gradient value of the initial control points in each of the at least two blocks in each of the at least two sub-regions. For each sub-region, the processing device 120 may order the at least two blocks based on the maximum gradient values of the initial control points in the at least two blocks, and determine a gradient threshold based on the proportion of the count of the one or more target control points in the sub-region to the count of all initial control points in the sub-region. The block with the maximum gradient value within the gradient threshold may be determined as a block where the one or more target control points are located, and an initial control point with the maximum gradient value in the block may be determined as the target control point. For example, the count of the one or more target control points C₁ in sub-region 1 of the first image is 40. If the count of the one or more initial control points in sub-region 1 is 200, the proportion of the count of the one or more target control points in sub-region 1 to the count of the one or more initial control points is 40/200*100%=5%. The processing device 120 may determine a maximum gradient value of a block in the 40th in an order of the maximum gradient values of the initial control points in sub-region 1 as the gradient threshold. Blocks in sub-region 1 with a maximum gradient value greater than or equal to the gradient threshold may be determined as the blocks where the one or more target control points of sub-region 1 are located, and initial control points with the maximum gradient values in the blocks may be determined as the target control points.

In some embodiments, for each sub-region, the processing device 120 may directly determine at least one block with a maximum gradient value among maximum gradient values of the at least two blocks in the sub-region, and take at least one initial control point with the maximum gradient value as at least one target control point in the at least one block. The count of target control points may be equal to the count of target control points assigned to the sub-region. For example, the count of target control points C₁ in sub-region 1 of the first image is 35, and the processing device 120 may order the at least two blocks in sub-region 1 in descending order of maximum gradient values. For each block in the top 35, the initial control points with the maximum gradient values may be taken as the target control points.

In some embodiments, the processing device 120 may order the one or more initial control points in one of the at least two sub-regions and obtain a preset count of control points (the preset count of control points may be the same as the count of the one or more target control points assigned to the sub-region) based on at least two of the grayscale values of the one or more initial control points in the sub-region, the gradient values of the one or more initial control points in the sub-region, and the maximum gradient value of the initial control points in each of the at least two blocks in the sub-region. The one or more target control points in the sub-region may be determined based on the preset count of control points. For example, a union group of the preset count of control points may be obtained, and a preset count of target control points may be randomly selected from the union group.

In some embodiments, the processing device 120 may determine the one or more target control points in each of the at least two sub-regions based on other features of the one or more initial control points (e.g., structural features of the scanning region, feature values of the data points, etc.) in each of the at least two sub-regions. For example, the processing device 120 may identify initial control points located in regions of focus, such as the focused organs/tissues (e.g., the aorta) as target control points. For example, the processing device 120 may allocate weights or the count of the one or more target control points in different sub-regions based on a degree of attention, from high to low. The higher the degree of attention is, the more weight or the count of the one or more target control points in the sub-region is. For example, for a certain sub-region, the processing device 120 may order the initial control points in a descending order of feature values, and determine the initial control points of a certain count (equal to the count of the one or more target control points assigned to the sub-region) that are ordered in the front as the target control points.

In some embodiments, the processing device 120 may obtain a second image, and generate a registering result by registering the first image to the second image based on the one or more target control points to obtain a registered first image.

In some embodiments, after determining target control points in the first image, the processing device 120 may determine control points in the second image whose positions are corresponding to the positions of the target control points in the first image (e.g., two points in the first image and the second image respectively may be points corresponding to the same anatomical structure in the two images, for example, the two points both are center points of the left ventricle). The processing device 120 may register the target control points in the first image and the corresponding control points in the second image to obtain a registration result (e.g., an image position deviation between the target control points in the first image and the corresponding control points in the second image). The processing device 120 may perform, based on the registration result, a pixel displacement on the first image (e.g., align structures of the first image with corresponding structures of the second image) to obtain a first image with a displacement. The first image with a displacement may be the registered first image.

In some embodiments, the processing device 120 may determine an image of an object of interest in the second image based on the registering result.

In some embodiments, after registering the first Image to the second image to obtain the registered first image, the processing device 120 may determine a difference between the second image and the registered first image, and determine an image of an object of interest in the second image based on the difference. The object of interest may include any body part such as the organs/tissues that a user is interested in.

In some embodiments, if no contrast agent is used when acquiring the second image, after obtaining the registration result, the processing device 120 may perform a pixel displacement on the second image based on the registration result (e.g., the image position deviation between the target control points in the first image and the corresponding control points in the second image) to obtain a second image with a displacement to register the second image to the first image. The second image with a displacement refers to a registered second image. The processing device 120 may determine a difference between the first image and the registered second image, and determine, based on the difference, the image of the object of interest in the second image.

In some embodiments, the processing device 120 may perform a pixel displacement on both of the first image and the second image based on the registration result (e.g., the image position deviation between the target control points in the first image and the corresponding control points in the second image) to obtain the first image with a displacement and the second image with a displacement for registration between the first image and the second image. The first image with a displacement refers to a registered first image, and the second image with a displacement refers to a registered second image. For example, the processing device 120 may move the pixels of the first image and the second image based on a third image (which is different from the first image and the second image, and the first image, the second image, and the third image may be scanning images of the same object at the same scanning position) to align the structures of the second image with the structures of the first image. In some embodiments, the processing device 120 may determine a difference between the registered first image and the registered second image, and determine, based on the difference, the image of the object of interest in the second image.

In some embodiments, the processing device 120 may overlay the registered first image with the second image (e.g., subtracting the first image from the second image) to obtain a subtracted image. The subtracted image may represent the difference between the second image and the registered first image. In some embodiments, the processing device 120 may overlap the first image/the first image with a displacement with the second image with a displacement to obtain the subtracted image. In some embodiments, the processing device 120 may determine the subtracted image as a target image, for example, the image of the object of interest. When the object of interest is a blood vessel, the target image may include a blood vessel information image.

In some embodiments of the present disclosure, the target control points of the at least two sub-regions of the first image may be determined based on the weights of the at least two sub-regions, so that the count of the one or more target control points in each of the at least two sub-regions directly correspond to the importance of the region. For example, the more important the region is, the more target control points there are, thus clearly highlighting the regions with significant structural changes. In this way, the selection of target control points is more reasonable and representative, which better reflects the position and contour boundaries of the object's organs/tissues, so that the pixel transformation can be realized better and more effectively, achieving the effect of removing motion artifacts.

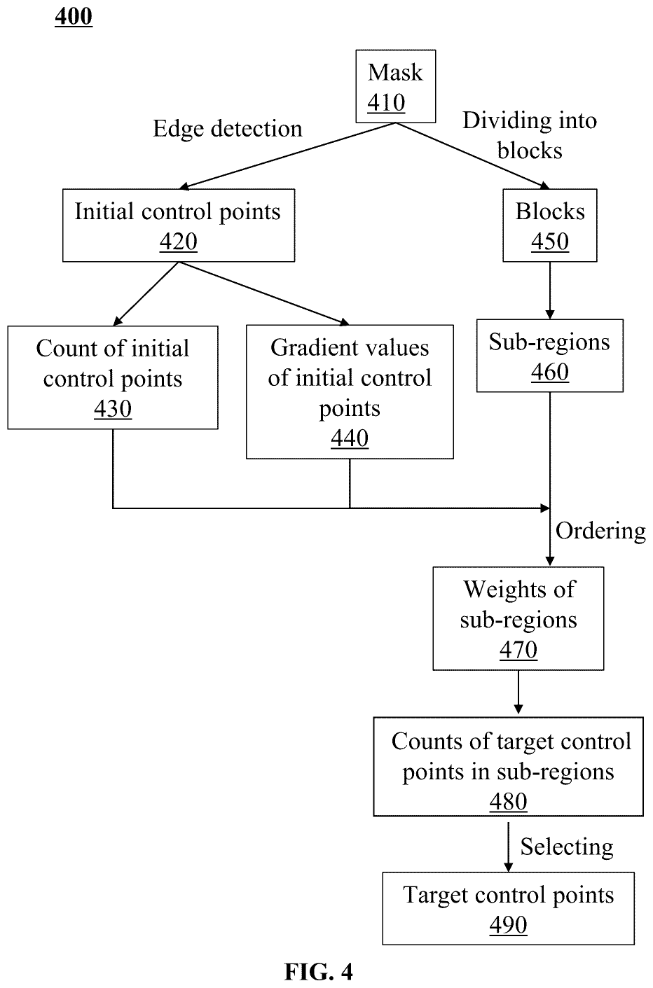

FIG. 4 is a schematic diagram illustrating an exemplary process for determining an image control point according to some embodiments of the present disclosure.

In the process of eliminating motion artifacts in a DSA image, a method of pixel displacement may be used, and the method of pixel displacement may need to select control points on an image. In some embodiments of the present disclosure, the control points on a mask image may be determined using the method shown in process 400 in FIG. 4. In some embodiments, process 400 may be executed by the processing device 120.

In some embodiments, a first image, e.g., a mask 410, may be obtained and a plurality of initial control points 420 in the mask 410 may be extracted using an edge detection algorithm (e.g., a gradient algorithm, a canny operator algorithm, a first-order differential edge operator algorithm, a Roberts operator algorithm, etc.).

In some embodiments, a count of the plurality of initial control points 430 and a plurality of gradient values 440 of the plurality of initial control points may be obtained based on the plurality of initial control points 420. The count of the plurality of initial control points 430 may include a total count of the plurality of initial control points in the mask 410, and the plurality of gradient values 440 of the plurality of initial control points may include a gradient value of each of the plurality of initial control points in the mask 410.

In some embodiments, the mask 410 may be divided into blocks obtain blocks 450, wherein the blocks 450 may include at least two blocks. In some embodiments, a count of the blocks may be determined based on a preset count of target control points. For example, for the mask 410, if the preset count of target control point is 40, the mask 410 may be divided into 40 blocks. In some embodiments, the count of the blocks may be N*N (N is a natural number greater than 1). For example, the mask 410 may be divided into 12*12 blocks, or 16*16 blocks.

In some embodiments, the mask 410 may be divided into regions to obtain sub-regions 460, the sub-regions 460 may include at least two sub-regions, and each sub-region may be divided into the at least two blocks. In some embodiments, a count of sub-regions in the mask 410 may be M*M (M is a natural number greater than 1 and N>M), and each of the at least two sub-regions may include (N/M)*(N/M) blocks. For example, if the mask 410 include 12*12 blocks and 4*4 sub-regions, then each sub-region may include 3*3 blocks.

In some embodiments, as shown in FIG. 4, the mask 410 may be divided into blocks 450, and then the at least two sub-regions may be divided based on the blocks 450 to obtain sub-regions 460.

In some embodiments, the mask 410 may be performed a region division to obtain the sub-regions 460, and then each of the sub-regions 460 may be divided into at least two blocks. A count of the at least two blocks in one of the sub-regions 460 may be determined based on a size of the one of the sub-regions 460. In some embodiments, the size of a block may be predetermined, and then the count of at least two blocks in the one sub-region may be determined based on the size of the block and the one sub-region.

In some embodiments, weights 470 of the sub-regions 460 may be obtained based on the plurality of initial control points 420.

In some embodiments, the sub-regions 460 may be ordered based on the count of the plurality of initial control points 430 and/or the plurality of gradient values 440 of the plurality of initial control point, and the weights 470 of the at least two sub-regions may be determined based on an ordering result. Weights of sub-regions in the front in the order may be greater than or equal to weights of sub-regions in the behind of the order.

In some embodiments, all sub-regions in the first image may be ordered based on relevant feature information of each sub-region (e.g., a sum of maximum gradient values of the at least two blocks, a sum of counts of initial control points in the at least two blocks, a maximum of the maximum gradient values of the at least two blocks, and a maximum of the counts of initial control points in the at least two blocks), a weight of each of the at least two sub-regions may be determined based on an order of the ordering result.

Merely by way of example, assuming that the mask 410 includes 12*12 blocks and 4*4 sub-regions, each sub-region includes 3*3 blocks. The 4*4 sub-regions are denoted as sub-region 1, sub-region 2, sub-region 3, . . . , sub-region 15, and sub-region 16. Sums of maximum gradient values of 3*3 blocks in each of the 16 sub-regions are denoted as T1, T2, T3, . . . , T15, and T16, respectively. Sums of counts of initial control points in the 3*3 blocks in each of the 16 sub-regions are denoted as D1, D2, D3, . . . , D15, and D16, respectively. If the ordering result is [T1 T2 T3 . . . . T15 T16] based on the sums of the maximum gradient values of the 9 blocks in each of the 16 sub-regions, an allocation result of weights for sub-region 1, sub-region 2, sub-region 3, . . . , sub-region 15, and sub-region 16 may be sequentially [9 9 8 8 7 6 6 6 5 4 3 3]. If the ordering result is [T2 T3 T1 . . . . T15 T14] based on the sums of the initial control points in the 9 blocks in each of the 16 sub-regions, the allocation result of weights for sub-region 1, sub-region 2, sub-region 3, . . . , sub-region 15, and sub-region 16 may be sequentially [8 9 9 8 7 7 6 6 6 6 6 5 4 3 4].

More information on how to determine the weights of the at least two sub-regions based on the counts of initial control points and/or the gradient values of initial control points may be found elsewhere in the present disclosure, for example, FIG. 5 and the relevant description, which may not be further repeated herein.

In some embodiments, the counts 480 of target control points in the at least two sub-regions may be determined based on the weights 470 of the at least two sub-regions. According to the counts 480 of target control points in the at least two sub-regions, a threshold-based selection may be performed on gray values of the initial control points in the each of the at least two sub-regions, the gradient values of the initial control points of the each of the at least two sub-regions, the maximum gradient values of initial control points in the each of the at least two blocks in the each of the at least two sub-regions to determine one or more target control points in each of the at least two sub-regions, e.g., the target control points 490. After the initial control points are selected based on the count or gradient values of the plurality of initial control points or gradient value, the count of target control points is significantly reduced compared to the count of the plurality of initial control points, and the structures in the image are also reflected well. More description on how to determine the one or more target control points in each of the at least two sub-regions based on the count of target control points in each of the at least two sub-regions may be found elsewhere in the present disclosure, for example, operation 340 in FIG. 3 and the relevant description, which may not be repeated herein.

In some embodiments, after the target control points 490 of the mask 410 are determined, the control point corresponding to the target control point 490 on an angiogram (e.g., a second image) may be determined based on the target control points 490. A pixel displacement may be performed on the mask 410 based on the target control points 490 and the corresponding control points on the angiogram, so that the same structure in the mask 410 and the angiogram may be aligned. By subtracting the mask 410 from the angiogram, a vascular information image may be obtained to eliminate the motion artifacts.

Merely by way of example, in block matching, the corresponding control points on the angiogram may be determined based on the target control points on the mask by the following operations. On the mask, the processing device 120 may obtain a block C centered on a target control point M, and determine a block D corresponding to the block C on the angiogram (e.g., a block with equal size and shape with the block C). The processing device 120 may move the block D on the angiogram based on a preset step size and a preset searching method, and recalculate a similarity between the block C and the block D. When the similarity reaches a maximum, a position of block D may be a position of a corresponding block that matches block C. At this time, a center N of block D is a position of the control point on the angiogram corresponding to the target control point M. In some embodiments, other image matching algorithms may also be used to determine the corresponding control points on the angiogram based on the target control points on the mask, for example, a matching algorithm based on machine learning models. The method of determining the corresponding control points on the angiogram based on the target control points on the mask may not be limited in the present disclosure.

FIG. 5 is a schematic diagram illustrating an exemplary process for determining an image control point according to some embodiments of the present disclosure.

In some embodiments, an order of at least two sub-regions may be determined based on a plurality of initial control points in the first image, and a weight of the each of the at least two sub-regions in the first image may be determined based on the order. As shown in the process 500 shown in FIG. 5, the initial control point 510 represents all of the plurality of initial control points in the first image. According to the initial control point 510 in the first image, the weight 580 of a sub-region corresponding to a sub-region 520 in the first image may be determined by ordering the at least two sub-regions in the first image.

In some embodiments, the order of at least two sub-regions may be determined based on gradient values of one or more initial control points in the each of the at least two sub-regions and/or a count of the one or more initial control points in the each of the at least two sub-regions in the first image.

In some embodiments, the count of the one or more initial control points and the gradient values of the one or more initial control points may be obtained based on the initial control point 510.

In some embodiments, each of the at least two sub-regions may be divided into at least two blocks. More description for dividing a sub-region into at least two blocks may be found elsewhere in the present disclosure, for example, FIG. 4 and the relevant description.

In some embodiments, a count of initial control points in each of the at least two blocks of each sub-region may be obtained based on the count of the one or more initial control points in the each of the at least two sub-regions and a block division result. Specifically, the initial control points in the each of the at least two blocks may be obtained based on the block division result. A total number of the initial control points may the count of the initial control points in the each of the at least two blocks.

In some implementations, the order of at least two sub-regions may be determined based on a maximum gradient value of each of the at least two blocks of the each of the at least two sub-regions and/or the count of initial control points in the each of the at least two blocks.

In some embodiments, at least one relevant feature information of each of the at least two sub-regions may be determined. The at least one relevant feature information may include a sum of maximum gradient values of the at least two blocks, a sum of counts of initial control points in the at least two blocks, a maximum of the maximum gradient values of the at least two blocks, and/or a maximum of the counts of initial control points in the at least two blocks in the each of the at least two sub-regions. As shown in FIG. 5, the sum 530 of counts of initial control points in the at least two blocks, the maximum 540 of the counts of initial control points in the at least two blocks may be determined based on counts of initial control points in each of the at least two blocks; the sum 560 of maximum gradient values of the at least two blocks and the maximum 570 of the maximum gradient values of the at least two blocks may be determined based on the maximum gradient values 550 of the at least two blocks.

In some embodiments, the at least one relevant feature information of each of the at least two sub-regions may also include a maximum of average values of gradient of initial control points in the each of the at least blocks, an average value of the maximum gradient values of the at least two blocks, an average value of gradient values of one or more initial control points in the each of the at least two sub-regions, an average of count of initial control points in the each of the at least two blocks, or the like. The maximum of average values of gradient of initial control points in the each of the at least blocks may be obtained by: averaging the gradient values of initial control points in each of the at least two blocks, and determining the maximum of the average values of gradient of initial control points in the each of the at least blocks. The average value of the maximum gradient values of the at least two blocks may be obtained by: obtaining the maximum gradient values of the at least two blocks; averaging the maximum gradient values of the at least two blocks, and determining the average value as the average value of the maximum gradient values of the at least two blocks. The average value of gradient values of one or more initial control points in the each of the at least two sub-regions may be obtained by averaging the gradient values of the one or more initial control points in each of the at least two sub-regions, and determining the average value as the average value of gradient values of one or more initial control points in the each of the at least two sub-regions. The average of count of initial control points in the each of the at least two blocks may be obtained by obtaining the counts of the initial control points in each of the at least two blocks, averaging the counts, and determining the average as the average of count of initial control points in the each of the at least two blocks.

In some embodiments, the maximum gradient value of each of the at least two blocks may be obtained based on the gradient values of the initial control points in the at least two blocks and the block division result. The maximum gradient value of each of the at least two blocks may refer to a maximum gradient value among all gradient values of the initial control points in each of the at least two blocks. As shown in FIG. 5, the all gradient values of initial control points in one of the at least two blocks may be obtained based on the gradient values of the initial control points, and the maximum of the all gradient values may be determined as the maximum gradient value 550 of the block. For example, for block A, 20 initial control points are included in the block A, and the maximum gradient value among the 20 initial control points is 36, then the maximum gradient value of block A is 36.

In some embodiments, the sum of the counts of initial control points in the at least two blocks may be determined based on a region division result of the first image. The sum of the counts of initial control points in the at least two blocks in each of the at least two sub-region may refer to a total number of initial control points in the at least two blocks in one sub-region, which may be the total number of initial control points in the sub-region. Specifically, all initial control points in one sub-region may be obtained based on the region division result, and the counts of the initial control points in the sub-region may be determined as the sum of the counts of initial control points in the at least two blocks in the sub-region, for example, the sum 530 of the counts of initial control points in the at least two blocks.

In some embodiments, the maximum of the counts of initial control points in the at least two blocks may be determined based on the region division result of the first image. The maximum of counts of the initial control points in the at least two blocks may refer to a maximum of counts of the initial control points in all blocks in one sub-region. Specifically, all blocks in the sub-region may be obtained based on the region division result and the block division result. The count of the initial control points in each of the at least two blocks may be obtained based on the counts of the initial control points in the at least two blocks. Since the count of initial control points in each of the at least two blocks are obtained, the maximum of the counts of initial control points in the at least two blocks may be determined, for example, the maximum of the counts of initial control points in the at least two blocks may be 540.

In some embodiments, the maximum of the maximum gradient values of the at least two blocks (i.e., the maximum gradient value of one of the at least two sub-regions) may be obtained based on the region division result of the first image. The maximum of the maximum gradient values of the at least two blocks refers to a maximum value of the maximum gradient values of all blocks in one sub-region. Specifically, the maximum gradient values of all blocks in the sub-region (e.g., a maximum gradient value of one of the at least two blocks may be 550) may be obtained based on the region division result and the block division result, and the maximum of the maximum gradient values of the all blocks may be determined as the maximum of the maximum gradient values of the at least two blocks in the sub-region, for example, the maximum value of the maximum gradient values of the at least two blocks may be 570. Merely by way of example, for a sub-region 1, there are four blocks in the sub-region 1: block 1, block 2, block 3, and block 4. The maximum gradient values of the four blocks are 36, 38, 23, and 45, with a maximum value of 45. Therefore, the maximum gradient value of the four blocks in the sub-region 1 is 45.

In some embodiments, the sum of maximum gradient values of the at least two blocks may be obtained based on the region division result. The sum of the maximum gradient values of the at least two blocks may refer to a sum of maximum gradient values of all blocks in one sub-region. Specifically, the maximum gradient values of all blocks (e.g., a maximum gradient value of one of the at least two blocks may be 550) in the sub-region may be obtained based on the region division result and the block division result. The maximum gradient values of all blocks may be summed as the sum of the maximum gradient values of all blocks in the sub-region, for example, the sum of the maximum gradient values of the at least two blocks may be 560. For example, for the sub-region 1, there are four blocks in the sub-region 1: block 1, block 2, block 3, and block 4. The maximum gradient values of the four blocks are 36, 38, 23, and 45, respectively. Therefore, the sum of the maximum gradient values of the four blocks in the sub-region 1 is 36+38+23+45=142.

In some embodiments, the order of the at least two sub-regions in the first image may be determined based on the at least one relevant feature information of each of the at least two sub-regions. The order of the at least two sub-regions in the first image refers to an ordering result obtained by ordering all sub-regions in the first image in a unit of a single sub-region. In some embodiments, all sub-regions of the first image may be ordered based on numerical values of one of the at least one relevant feature information of each of the at least two sub-regions, such as at least one of the sum of maximum gradient values of the at least two blocks, the sum of counts of initial control points in the at least two blocks, the maximum of the maximum gradient values of the at least two blocks, or the maximum of the counts of initial control points in the at least two blocks. Values of the at least one relevant feature information of each of the at least two sub-regions may be ordered from large to small, with a sub-region with larger value ordering in the front and a sub-region with smaller value ordering in the behind.

In some embodiments, the order of the at least two sub-regions in the first image may be determined based on a combination of the at least one relevant feature information of each of the at least two sub-regions. For example, each of the at least one relevant feature information of each of the at least two sub-regions may be given corresponding weights, and a sum of the weight of the at least one related information may be designated as an ordering basis of the at least two sub-regions.

In some embodiments of the present disclosure, the at least one relevant feature information of each of the at least two sub-regions may be obtained based on the count and the gradient values of the one or more initial control points in the one of the at least two sub-regions, and the at least two sub-regions may be ordered based on the values of the at least one related information, so that the ordering result comprehensively and accurately reflects a distribution and features of the one or more initial control points in the one of the at least two sub-regions in the first image from multiple perspectives, thereby making the ordering result more reasonable, and achieving the extraction of important regions in the first image.

It should be noted that the above descriptions for processes 300, 400, and 500 is merely for example and explanation, and may not limit the scope of the present disclosure. For these skills in the art, various modifications and changes may be made to processes 300, 400, and 500 under the guidance of the present disclosure. However, these modifications and changes are still within the scope of the present disclosure. For example, an order of dividing the at least two sub-regions and the at least two blocks in process 400 may be interchanged.

The beneficial effects of the embodiments of the present disclosure may include, but may not be limited to the followings. (1) Structural information is extracted from an image using an edge extraction algorithm and a plurality of initial control points are obtained based on the extracted structural information, so that a count of the plurality of control points is sufficient to comprehensively reflect the structural information in the image. (2) By utilizing various information such as the count of the plurality of initial control points and/or gradient values of the plurality of initial control points, the at least two sub-regions are ordered and assigned to different weights, which reflects the importance of different sub-regions in the image, thereby achieving the extraction of an important region from the image. (3) The one or more target control points in the at least two sub-regions are determined based on the weights of the at least two sub-regions. Thus, for the one or more target control points, the important region may be divided into more control points, which accurately controls the count of target control points, so that the count of target control points is not too large, thereby reducing computational complexity and resource consumption. At the same time, as much structural information of the image as possible is remained in a limited computational space, so that a pixel displacement is effectively completed, ultimately achieving the effect of effectively eliminating motion artifacts and obtaining a clear and accurate vascular information image. It should be noted that different embodiments may produce different beneficial effects, and in different embodiments, the possible beneficial effects may be any one or a combination of the above, or any other possible beneficial effects.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. Furthermore, the particular features, structures or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A method implemented on at least one machine each of which has at least one processor and at least one storage device for determining an image control point, comprising:
obtaining a first image;
determining a plurality of initial control points in the first image;
dividing the first image into at least two sub-regions; and
determining, based on one or more features of the plurality of initial control points, one or more target control points in each of the at least two sub-regions.

2. The method of claim 1, wherein the determining a plurality of initial control points in the first image includes:
extracting the plurality of initial control points in the first image using an edge detection algorithm.

3. The method of claim 1, wherein the determining a plurality of initial control points in the first image includes:
extracting feature values of a plurality of data points of the first image;
selecting at least one seed point from the plurality of data points based on the feature values of the plurality of data points; and
determining, based on the at least one seed point and a distance threshold, the plurality of initial control points from the plurality of data points.

4. The method of claim 3, wherein the distance threshold is related to a distance between two regions of interest (ROIs) in the first image.

5. The method of claim 1, wherein the dividing the first image into at least two sub-regions includes:
dividing the first image to obtain the at least two sub-regions based on at least one of the one or more features of the plurality of initial control points.

6. The method of claim 1, wherein the dividing the first image into at least two sub-regions includes:
extracting a region of interest (ROI) of the first image; and
dividing the ROI of the first image to obtain the at least two sub-regions.

7. The method of claim 1, wherein the determining, based on one or more features of the plurality of initial control points, one or more target control points in each of the at least two sub-regions includes:
determining, based on the one or more features of the plurality of initial control points, a weight of the each of the at least two sub-regions; and
determining, based on the weight of the each of the at least two sub-regions and the plurality of initial control points, the one or more target control points in the each of the at least two sub-regions.

8. The method of claim 7, wherein the determining, based on the one or more features of the plurality of initial control points, a weight of the each of the at least two sub-regions includes:
determining, based on the one or more features of the plurality of initial control points, an order of the at least two sub-regions; and
determining, based on the order, the weight of the each of the at least two sub-regions.

9. The method of claim 8, wherein the determining, based on the one or more features of the plurality of initial control points, an order of the at least two sub-regions includes:
determining, based on at least one of gradient values of one or more initial control points in the each of the at least two sub-regions or a count of the one or more initial control points in the each of the at least two sub-regions, the order of the at least two sub-regions.

10. The method of claim 9, wherein the determining, based on at least one of gradient values of one or more initial control points in the each of the at least two sub-regions or a count of the one or more initial control points in the each of the at least two sub-regions, the order of the at least two sub-regions includes:
dividing the each of the at least two sub-regions into at least two blocks; and
determining, based on at least one of a maximum gradient value of each of the at least two blocks of the each of the at least two sub-regions or a count of initial control points in the each of the at least two blocks, the order of the at least two sub-regions.

11. The method of claim 10, wherein the determining, based on at least one of a maximum gradient value of each of the at least two blocks of the each of the at least two sub-regions or a count of initial control points in the each of the at least two blocks, the order of the at least two sub-regions includes:
for the each of the at least two sub-regions, determining at least one of a sum of maximum gradient values of the at least two blocks, a sum of counts of initial control points in the at least two blocks, a maximum of the maximum gradient values of the at least two blocks, or a maximum of the counts of initial control points in the at least two blocks; and
determining, based on the at least one of the sum of maximum gradient values of the at least two blocks, the sum of counts of initial control points in the at least two blocks, the maximum of the maximum gradient values of the at least two blocks, or the maximum of the counts of initial control points in the at least two blocks, the order of the at least two sub-regions.

12. The method of claim 10, wherein the determining, based on the weight of the each of the at least two sub-regions and the plurality of initial control points, the one or more target control points in the each of the at least two sub-regions includes:
determining, based on the weight, a count of target control points in the each of the at least two sub-regions; and
determining the one or more target control points in the each of the at least two sub-regions by performing a threshold-based selection on at least one of gray values of the initial control points in the each of the at least two sub-regions, gradient values of the initial control points of the each of the at least two sub-regions, or maximum gradient values of initial control points in the each of the at least two blocks in the each of the at least two sub-regions.

13. The method of claim 8, wherein the determining, based on the order, the weight of the each of the at least two sub-regions includes:
assigning a greater weight to a high-ranked sub-region of the at least two sub-regions compared with a low-ranked sub-region of the at least two sub-regions.

14. The method of claim 1, further comprising:
obtaining a second image;
generating a registering result by registering the first image to the second image based on the one or more target control points to obtain a registered first image; and
determining, based on the registering result, an image of an object of interest in the second image.

15. The method of claim 14, wherein the first image includes a mask, and the second image includes an angiogram.

16. The method of claim 1, further comprising:
obtaining a second image;
obtaining, in the second image, one or more control points corresponding to the one or more target control points in the first image;
generating a registering result based on the one or more target control points in the first image and the one or more corresponding control points in the second image;
obtaining a registered first image by performing, based on the registration result, a pixel displacement on the first image to align structures of the first image with corresponding structures of the second image;
determining an image of an object of interest in the second image based on the second image and the registered first image.

17. A system for determining an image control point, comprising:
at least one storage device storing a set of instructions; and
at least one processor in communication with the storage device, wherein when executing the set of instructions, the at least one processor is configured to cause the system to perform operations including:
obtaining a first image;
determining a plurality of initial control points in the first image;
dividing the first image into at least two sub-regions; and
determining, based on one or more features of the plurality of initial control points, one or more target control points in each of the at least two sub-regions.

18. The system of claim 17, wherein to determine, based on one or more features of the plurality of initial control points, one or more target control points in each of the at least two sub-regions, the at least one processor is further configured to cause the system to perform operations including:
determining, based on the one or more features of the plurality of initial control points, a weight of the each of the at least two sub-regions; and
determining, based on the weight of the each of the at least two sub-regions and the plurality of initial control points, the one or more target control points of each in the at least two sub-regions.

19. The system of claim 18, wherein to determine, based on the one or more features of the plurality of initial control points, a weight of the each of the at least two sub-regions, the at least one processor is further configured to cause the system to perform operations including:
determining, based on the one or more features of the plurality of initial control points, an order of the at least two sub-regions; and
determining, based on the order, the weight of the each of the at least two sub-regions.

20-21. (canceled)

22. A non-transitory computer readable medium storing instructions, the instructions, when executed by at least one processor, causing the at least one processor to implement a method comprising:
obtaining a first image;
determining a plurality of initial control points in the first image;
dividing the first image into at least two sub-regions; and
determining, based on one or more features of the plurality of initial control points, one or more target control points in each of the at least two sub-regions.
